(19) United States
(12) Patent Application Publication
(10) Pub. No.: US 2026/0234981 A1
(43) Pub. Date: Aug. 13, 2026

(54) ASSEMBLY FOR PRODUCING THE DOOR DRIVE DEVICE FOR ADJUSTING A VEHICLE DOOR RELATIVE TO A VEHICLE BODY

(71) Applicant: Brose Fahrzeugteile SE & Co. Kommanditgesellschaft, Bamberg, Bamberg (DE)

(72) Inventors: Daniel SCHNAPP, Ebensfeld (DE); Tobias GAGEL, Zapfendorf (DE)

(21) Appl. No.: 19/535,746

(22) Filed: Feb. 10, 2026

(30) Foreign Application Priority Data
Feb. 13, 2025 (DE) 102025105402.9

(51) Int. Cl. E05F 15/622

(52) U.S. Cl. CPC E05F 15/622; E05Y 2201/10; E05Y 2201/71; E05Y 2600/632; E05Y 2900/531

(57) ABSTRACT

An assembly for producing a door drive device for adjusting a vehicle door relative to a vehicle body comprises a motor having a motor shaft rotatable about a motor axis, a transmission having at least one gear wheel, a housing assembly to which the motor can be connected, a spindle rotatable about a longitudinal axis, a push rod, and an adapter element for connecting the door drive device to the vehicle door or the vehicle body. The housing assembly for mounting the door drive device can be connected to the adapter element. In a pre-assembly state, the housing assembly can be connected to the adapter element in different positions rotated relative to each other about the longitudinal axis.

### CROSS-REFERENCE TO RELATED APPLICATIONS

This application claims priority pursuant to 35 U.S.C. 119(a) to German Application No. 102025105402.9, filed February 13, 2025, which application is incorporated herein by reference in its entirety.

### FIELD OF THE INVENTION

The disclosure relates to an assembly for producing the door drive device for adjusting a vehicle door relative to a vehicle body. The proposed solution also relates to a door drive device and a method for producing a door drive device.

### BACKGROUND OF THE INVENTION

Such an assembly includes a motor which has a motor shaft that can rotate about a motor axis. The assembly also includes a transmission which has at least one gear wheel, a housing assembly to which the motor can be connected, a spindle rotatable about a longitudinal axis, a push rod, and an adapter element for connecting the door drive device to the vehicle door or the vehicle body. The housing assembly can be connected to the adapter element for mounting the door drive device. In a mounted position, the motor is connected to the adapter element via the housing assembly. In the mounted position, the motor is operatively connected to the spindle via the transmission, and the spindle is driven by the motor to rotate about the longitudinal axis in order to move the push rod for adjusting the vehicle door.

A door drive device for adjusting a vehicle door relative to a vehicle body is known, for example, from DE 10 2018 131 933 A1.

Another design of a door drive device with a spindle drive is known from WO 2021/023893 A1. This door drive device includes an adapter element that is connected to a housing assembly and serves to fix the door drive device to a vehicle door. A motor is connected to the adapter element via the housing assembly and is fixed in an operational position on the vehicle door via the adapter element.

While the design of a housing assembly of a door drive device, as known, for example, from WO 2021/023893 A1, is determined by the design of the door drive device, the adapter element is designed so that the door drive device can be installed in a specific vehicle model. The adapter element is usually individually adapted to a specific vehicle model.

If the alignment of the motor relative to the vehicle door needs to be adapted, this traditionally requires a redesign, especially of the housing assembly, which is costly and may necessitate using different housing assemblies for different vehicle models.

### SUMMARY OF THE INVENTION

The object of the proposed solution is to provide an assembly for producing a door drive device, a door drive device, and a method for producing the door drive device, which enable a simple, cost-effective design, in particular of a housing assembly.

This object is achieved by an assembly for producing a door drive device with the features described herein.

Accordingly, it is intended that, in a pre-assembly state, the housing assembly can be connected to the adapter element in different positions rotated relative to each other about the longitudinal axis.

Traditionally, the adapter element is individually adapted to a vehicle model according to the wishes of a vehicle manufacturer and enables the installation of the door drive device by connecting the adapter element to the vehicle. While, conventionally, an interface between the housing assembly and the adapter element allows the housing assembly to be attached to the adapter element in only one defined position, in this case it is provided that the housing assembly be able to be connected to the adapter element in different positions rotated relative to each other about the longitudinal axis of the spindle nut. The housing assembly can thus be connected to the adapter element during the installation of the door drive device by aligning it in a plane perpendicular to the longitudinal axis.

This allows, in particular, the alignment of the motor axis about the longitudinal axis along which the spindle extends. The installation position of the motor can thus be adapted by the variable connection of the housing assembly to the adapter element, so that a uniform housing design of the housing assembly can be used for different orientations of the motor about the longitudinal axis of the spindle.

The motor axis corresponds to the axis about which the motor shaft of the motor can rotate. By contrast, the longitudinal axis corresponds to the axis about which the spindle can be rotated to move the push rod. The motor axis is generally different from the longitudinal axis. The variable alignment of the housing assembly relative to the adapter element allows the position of the motor axis relative to the longitudinal axis to be adapted, thus enabling variable selection of the motor's orientation for installation in the vehicle door or vehicle body.

Because no individual housing design is required to adapt the motor's orientation, a cost advantage can result. A housing assembly, through which the motor is connected to the adapter element and which, for example, encloses gear elements of the transmission, is usually highly complex and therefore requires a complex tool, such as an injection mold. Because no modification or redesign of the housing assembly, and therefore no new tooling for producing a modified housing assembly, is required when an adaptation of the motor's orientation is desired for installation in a specific vehicle model, the production costs for the door drive device are reduced.

The housing assembly can be connected to the adapter element in different positions, rotated relative to each other about the longitudinal axis. The angular position of the housing assembly relative to the adapter element can therefore be selected variably about the longitudinal axis, wherein the angular position can be selected, for example, in a full circle (360°) about the longitudinal axis or, if necessary, only in an angular range of a partial circle (less than 360° - for example, less than 180°).

In the mounted position, the housing assembly is advantageously firmly and immutably connected to the adapter element. In the operational, mounted position, there is therefore a fixed connection between the housing assembly and the adapter element, so that the motor is connected to the adapter element in a positionally fixed manner via the housing assembly.

The motor axis is generally different from the longitudinal axis. The motor axis is preferably not extended parallel to the longitudinal axis, i.e., it has a different direction than the longitudinal axis.

In particular, the motor axis, about which the motor shaft can rotate, can be arranged skewed with respect to the longitudinal axis. A skewed arrangement, in geometric terms, means that the motor axis and the longitudinal axis neither intersect nor are parallel to each other. Due to the skewed arrangement, a drive element arranged on the motor shaft, e.g., a drive worm, can engage with a gear wheel that is rotatable about the longitudinal axis - for example, a spur gear with straight teeth or helical teeth.

The motor axis can, for example, extend along a plane perpendicular to the longitudinal axis. By selecting the rotational position of the housing assembly about the longitudinal axis, the position of the motor axis in the plane perpendicular to the longitudinal axis can be determined. However, such an arrangement of the motor axis is not mandatory. In particular, the motor axis may not be aligned perpendicular to the longitudinal axis, e.g., it may be skewed at an oblique angle to the longitudinal axis, so that, by selecting the rotational position of the housing assembly about the longitudinal axis relative to the adapter element, the position of the motor axis along a funnel-shaped envelope can be selected.

In one embodiment, the transmission housing has a first attachment portion, and the adapter element has a second attachment portion. The first attachment portion and the second attachment portion can be attached to each other in different positions rotated about the longitudinal axis in order to connect the housing assembly to the adapter element. In the pre-assembly state, the housing assembly and the adapter element are separate from each other. To connect the housing assembly to the adapter element, the first attachment portion of the housing assembly and the second attachment portion of the adapter element are attached to each other, wherein the attachment is possible in different positions rotated relative to each other about the longitudinal axis, and thus an angular position of the housing assembly relative to the adapter element can be set in the desired way.

The first attachment portion and the second attachment portion can be shaped in such a way that pre-positioning of the housing assembly on the adapter element is possible by attaching the first attachment portion and the second attachment portion to each other. For example, it is conceivable and possible that the first attachment portion and the second attachment portion, in an attached position relative to each other, be able to be rotated about the longitudinal axis in order to adapt the angular position of the housing assembly relative to the adapter element. By attaching the attachment portions to each other, the housing assembly and the adapter element are pre-positioned and can then be aligned relative to each other by rotating the attachment portions.

In one embodiment, the first attachment portion and/or the second attachment portion are cylindrically shaped about the longitudinal axis. For example, one of the attachment portions can have the shape of a cylindrical pin, to which the other attachment portion can be attached in order to pre-position the attachment portions against each other.

In one embodiment, one of the first attachment portion and the second attachment portion has an opening into which the other of the first attachment portion and the second attachment portion can be inserted to connect the housing assembly to the adapter element.

For example, the first attachment portion and the second attachment portion are shaped in such a complementary way that the first attachment portion and the second attachment portion can be attached to each other and rotated relative to each other in an attached position. For example, one of the attachment portions can be in the shape of a cylindrical pin and the other attachment portion can be hollow-cylindrical, so that one attachment portion can be inserted into the other attachment portion.

It is possible that the first attachment portion and the second attachment portion, in an adjacent position, can be rotated relative to each other in order to adapt the alignment of the housing assembly relative to the adapter element. For this purpose, at least one of the attachment portions can, for example, have a rotationally symmetric shape, such as a cylindrical or hollow-cylindrical shape, so that, in the contacted position, it is possible to rotate the attachment portions relative to each other.

However, this is not mandatory. It is also conceivable and possible that the first and second attachment portions be able to be attached to each other in different positions rotated about the longitudinal axis, but that, once the attachment portions are attached to each other, it no longer be possible to rotate them. For example, the first attachment portion and the second attachment portion can each have a toothed portion or a differently shaped, form-fit portion, wherein the attachment portions engage with each other in the position attached to one another, in such a way that the attachment portions are fixed rotationally relative to each other. The attachment portions can therefore be connected to one another in different positions. However, once the attachment portions have been attached to each other, it is no longer possible to rotate the attachment portions relative to each other.

In the mounted position, the first attachment portion and the second attachment portion are preferably firmly and non-detachably connected to each other in such a way that the first attachment portion and the second attachment portion cannot detach from each other during operation of the door drive device (under loads occurring due to operation). The attachment portions are thus fixed rotationally relative to each other, so that the motor is held in a defined position relative to the adapter element via the housing assembly and is fixed to an associated vehicle assembly, viz., the vehicle door or the vehicle body, via the adapter element.

In particular, the first attachment portion and the second attachment portion can be connected to each other in the mounted position by an integrally bonded or form-fitting connection.

An integrally bonded connection can be created, for example, by a welded connection or an adhesive connection. Through such an integrally bonded connection, the first attachment portion and the second attachment portion are fixed relative to each other after attachment, so that the attachment portions and thus the housing assembly and the adapter element are firmly and non-detachably connected to each other.

A welded joint can be produced, for example, by laser transmission welding, ultrasonic welding, friction welding, or another welding process.

A form-fit connection can be achieved, for example, via a snap-fit connection or a clip connection, whereby the attachment portions are fixed axially along the longitudinal axis and are also fixed rotationally about the longitudinal axis relative to each other.

In other designs, it is also possible to fix the attachment portions to each other, for example, via a screw connection, and thus connect them in a positionally secure manner.

In one embodiment, the first attachment portion and the second attachment portion can be connected to each other in positions that are continuously adjacent to each other about the longitudinal axis or in discrete positions that are angularly spaced from each other about the longitudinal axis.

If the first attachment portion and the second attachment portion can be connected to each other in positions that are continuously connected about the longitudinal axis, then the first attachment portion and the second attachment portion can be connected to each other in any angular position, at least within a predetermined angular range. For this purpose, the first attachment portion and/or the second attachment portion can be shaped to be rotationally symmetric with respect to the longitudinal axis, e.g., by a cylindrical portion on one side and a hollow-cylindrical portion on the other, so that the attachment portions can be inserted into each other and continuously rotated relative to each other in the attached position. At least within a predetermined angular range, the housing assembly and the adapter element can therefore be connected to each other in any angular position.

If, on the other hand, the first attachment portion and the second attachment portion can be connected to each other in discrete positions spaced at an angle to each other about the longitudinal axis, then several discrete positions spaced at an angle to each other are defined in which the attachment portions can be connected to each other. If, for example, the attachment portions each have a toothed portion, the toothed portions can only be attached to each other in discrete positions spaced apart from each other according to a tooth width. Such discrete positions can also be defined by other types of form-fit portions - for example, a rib structure on one attachment portion in combination with a complementary groove arrangement on the other attachment portion.

If necessary, it may also be provided that the housing assembly be able to be connected to the adapter element in only one discrete position. Different adapter elements, specific to different vehicles, can be provided, wherein the housing assembly is universal for the different vehicles and can therefore be connected to the different adapter elements in the same way. The angular position of the housing assembly on the different adapter elements can vary, wherein the housing assembly can be connected to each adapter element only in a (single) discrete angular position.

In one embodiment, the assembly includes a spindle nut element for moving the push rod. The spindle nut element is in the mounted position with the spindle in a threaded connection such that, by rotating the spindle, the spindle nut element can be moved along the longitudinal axis relative to the spindle. For assembly, the spindle nut element is positioned on the spindle before, during or after connecting the housing assembly to the adapter element, thus bringing it into threaded connection to the spindle. The spindle has an external thread and engages with a threaded opening of the spindle nut element in such a way that, in the operational, mounted position, the spindle nut element is adjusted longitudinally along the longitudinal axis of the spindle when the spindle is rotated due to the threaded connection.

In one embodiment, the push rod is in the mounted position articulatedly connected to the spindle nut element. The push rod can be articulated to the spindle nut element, in particular about a pivot axis perpendicular to the longitudinal axis, so that the position of the push rod can be adapted about the longitudinal axis relative to the spindle nut element during operation.

In one embodiment, the assembly has a guide rail for guiding the spindle nut element. In one embodiment, the guide rail is formed on the adapter element. In other embodiments, the guide rail is attached to a mounting interface of the adapter element, at least in the mounted position. Regardless of the specific way the guide rail is connected to the adapter element (either by forming it in one piece with the adapter element or by connecting it via the fastening interface with the adapter element), the guide rail is fixedly connected to the adapter element. If the adapter element and the guide rail are designed separately, the position of the guide rail relative to the adapter element is defined via the fastening interface in such a way that the guide rail can be connected to the adapter element only in one position.

The position of the guide rail relative to the adapter element is therefore not adaptable. It follows that, due to the variable adaptability of the position of the housing assembly relative to the adapter element, the position of the housing assembly can also be adapted relative to the guide rail. However, because the guide rail is connected to the adapter element, this does not necessarily require special, elaborate measures for connecting the guide rail to the housing assembly.

In one embodiment, the housing assembly can be moved about the longitudinal axis relative to the guide rail in the pre-assembly state. In the pre-assembly state, the guide rail can therefore already be connected to the adapter element, e.g., by forming the guide rail in one piece with the adapter element or, if the adapter element and the guide rail are produced as separate components, by already being connected to the adapter element. In this pre-assembly state, the housing assembly can also be moved relative to the guide rail.

In one embodiment, a component unit from the group of housing assembly and guide rail has a support element which, in the pre-assembly state, is supported on the other component unit from the group of housing assembly and guide rail in a manner movable about the longitudinal axis. The support element is arranged accordingly on the housing assembly or on the guide rail and supported on the other component unit. The support element can, for example, provide axial support for the guide rail and the housing assembly relative to each other. The support is designed in such a way that, in the pre-assembly state, the housing assembly can be moved about the longitudinal axis at least within a certain angular range relative to the guide rail.

In one embodiment, the support element has (at least) one support leg which engages in a slot opening of the other component unit from the group of housing assembly and guide rail and is movable in the slot opening about the longitudinal axis. The support leg and the slot opening can, for example, each extend along a plane perpendicular to the longitudinal axis. The support leg engages in the slot opening, thus providing axial support between the housing assembly and the guide rail. However, the support leg is movable about the longitudinal axis in the slot opening, so that the position of the housing assembly can (also) be adapted relative to the guide rail.

In one embodiment, the housing assembly, in the mounted position, accommodates at least one gear wheel of the transmission. The housing assembly can, in particular, constitute a transmission housing for enclosing and/or rotatably mounting components of the transmission.

For example, a gear wheel is connected for conjoint rotation to the spindle and can be driven by the motor. For example, the gear wheel is formed by a spur gear which engages with a drive worm arranged on the motor shaft, so that, by driving the drive worm, the gear wheel can be set into a rotary motion about the longitudinal axis, and thus the spindle can be rotated. Both the gear wheel and the drive worm are preferably enclosed in the housing assembly and, in advantageous embodiments, are rotatably mounted in the housing assembly.

In one embodiment, the housing assembly has a motor interface for connecting the motor to the housing assembly. The motor can be screwed to the housing assembly via the motor interface, thus connecting it firmly. The positioning and alignment of the housing assembly relative to the adapter element can take place before, during, or after connecting the motor to the motor interface.

In one embodiment, the adapter element has an opening through which the push rod extends in the mounted position. By moving the spindle nut element, to which the push rod is preferably articulated, the push rod can be moved relative to the adapter element and, for example, can be adjusted between a retracted position and an extended position relative to the adapter element. In the retracted position, one end of the push rod, located away from the spindle nut element, is approaching the adapter element. In the extended position, the end of the push rod located away from the spindle nut element is, by contrast, further away from the adapter element. If the adapter element is connected to the door frame of a vehicle door, the end of the push rod located away from the spindle nut element is connected to the vehicle body, so that, by moving the push rod, the vehicle door can be moved relative to the vehicle body. The door drive device can preferably be arranged inside the door box and thus inside the vehicle door, with the push rod extending through the opening in the adapter element and through a door inner panel surrounding the door box.

In one embodiment, the adapter element has at least one fastening element for firmly connecting the adapter element to the vehicle door or the vehicle body. Such a fastening element can, for example, be formed by a screw, so that the adapter element can be screwed to the vehicle body or the vehicle door and thus firmly connected to the vehicle body or the vehicle door.

A door drive device produced using an assembly of the type described above has: a motor having a motor shaft rotatable about a motor axis; a transmission having at least one gear wheel; a housing assembly to which the motor is connected; a spindle rotatable about a longitudinal axis; a push rod; and an adapter element for connecting the door drive device to the vehicle door or the vehicle body; wherein the housing assembly is connected to the adapter element; wherein the motor is connected to the adapter element via the housing assembly; wherein the motor is operatively connected to the spindle via the transmission, and the spindle is rotatable about the longitudinal axis by the motor to move the push rod to adjust the vehicle door. The housing assembly is connected to the adapter element in one of several different positions, rotated relative to each other about the longitudinal axis.

A method for producing a door drive device using an assembly of the type described above involves: providing a motor having a motor shaft rotatable about a motor axis; providing a transmission having at least one gear wheel; providing a housing assembly to which the motor can be connected; providing a spindle rotatable about a longitudinal axis; providing a push rod; and providing an adapter element for connecting the door drive device to the vehicle door or vehicle body; wherein the housing assembly is connected to the adapter element for mounting the door drive device, such that, in a mounted position, the motor is connected to the adapter element via the housing assembly, wherein, in the mounted position, the motor is operatively connected to the spindle via the transmission, and the spindle is rotatable about the longitudinal axis by the motor to move the push rod for adjusting the vehicle door; wherein connecting the housing assembly to the adapter element comprises: aligning the motor axis relative to the longitudinal axis by connecting the housing assembly to the adapter element in a plurality of different positions rotated relative to each other about the longitudinal axis.

The advantages and beneficial designs described above for the assembly also apply analogously to the door drive device and the method for producing the door drive device, such that reference shall be made to the preceding explanations.

### BRIEF DESCRIPTION OF THE DRAWINGS

The idea underlying the proposed invention will be explained in more detail below with reference to the exemplary embodiments shown in the figures. In the figures:

FIG. 1 shows a schematic view of a vehicle door on a vehicle body;

FIG. 2 shows an exemplary embodiment of a door drive device for adjusting the vehicle door relative to the vehicle body, in an extended position of a push rod;

FIG. 3 shows another view of the door drive device;

FIG. 4 shows a view of the door drive device without a guide rail;

FIG. 5 shows another view of the arrangement according to FIG. 4;

FIG. 6 shows a view of the door drive device (without the guide rail) in a retracted position of the push rod;

FIG. 7 shows a view of the door drive device, without the push rod, a spindle nut element, and a motor;

FIG. 8 shows another view of the arrangement according to FIG. 7;

FIG. 9 shows a view of a housing assembly of the door drive device together with a spindle;

FIG. 10 shows another view of the arrangement according to FIG. 9;

FIG. 11 shows a frontal view of the arrangement according to FIGS. 9 and 10;

FIG. 12 shows a view of an adapter element together with the spindle, the spindle nut element, and the push rod;

FIG. 13 shows a separate view of the adapter element;

FIG. 14 shows another view of the adapter element;

FIG. 15 shows a partially enlarged view of the housing assembly together with the guide rail;

FIG. 16 shows a schematic view of an attachment portion of the housing assembly and an attachment portion of the adapter element;

FIG. 17 shows a schematic view of another exemplary embodiment of the attachment portions;

FIG. 18 shows a view of a door drive device with a guide rail, according to another exemplary embodiment; and

FIG. 19 shows an enlarged, partial sectional view of the door drive device, depicting a support element on a housing assembly for supporting the guide rail.

### DETAILED DESCRIPTION OF THE INVENTION

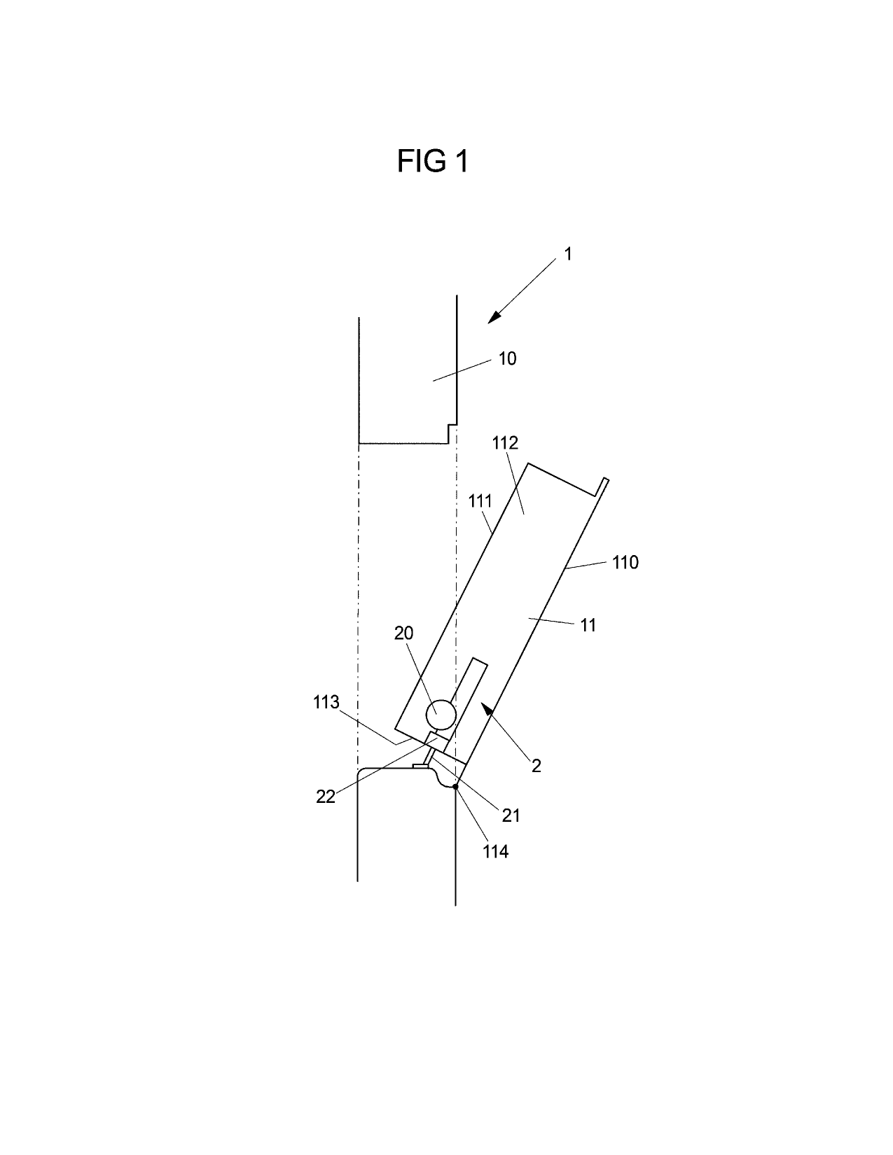

FIG. 1 shows a schematic view of a detail of a vehicle 1, which has a vehicle body 10 and a vehicle door 11 arranged pivotably on the vehicle body 10 about a hinge axis 114.

The vehicle door 11 can be pivoted about the hinge axis 114 relative to the vehicle body 10 in order to close an opening in the vehicle body 10 in a closed position or to release it in an open position, so that a user can enter the vehicle 1 or exit the vehicle 1. The vehicle door 11 can, in particular, be a front side door or a rear side door.

The vehicle door 11 has a door outer panel 110 and a door inner panel 113, which, together with a door module 111 attached to the door inner panel 113, define a door box that encloses a door interior 112.

In the illustrated exemplary embodiment, a door drive device 2 is arranged within the vehicle door 11 and is designed for electrically adjusting the vehicle door 11 relative to the vehicle body 10 or at least for electrically assisted, manual adjustment of the vehicle door 11 relative to the vehicle body 10.

In the illustrated exemplary embodiment, the door drive device 2 has a motor 20 implemented by an electric motor and a push rod 21 which can be adjusted by the motor 20 in order to effect an adjusting force between the vehicle door 11 and the vehicle body 10.

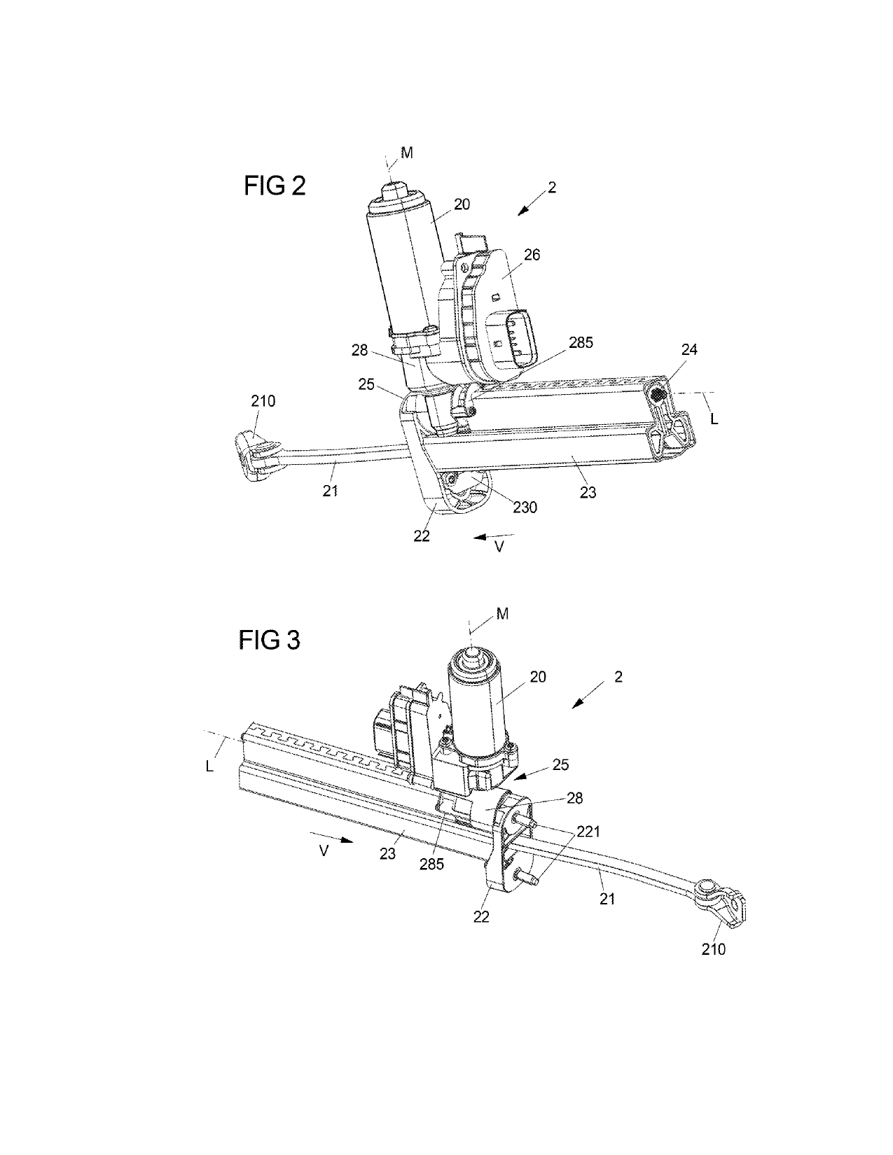

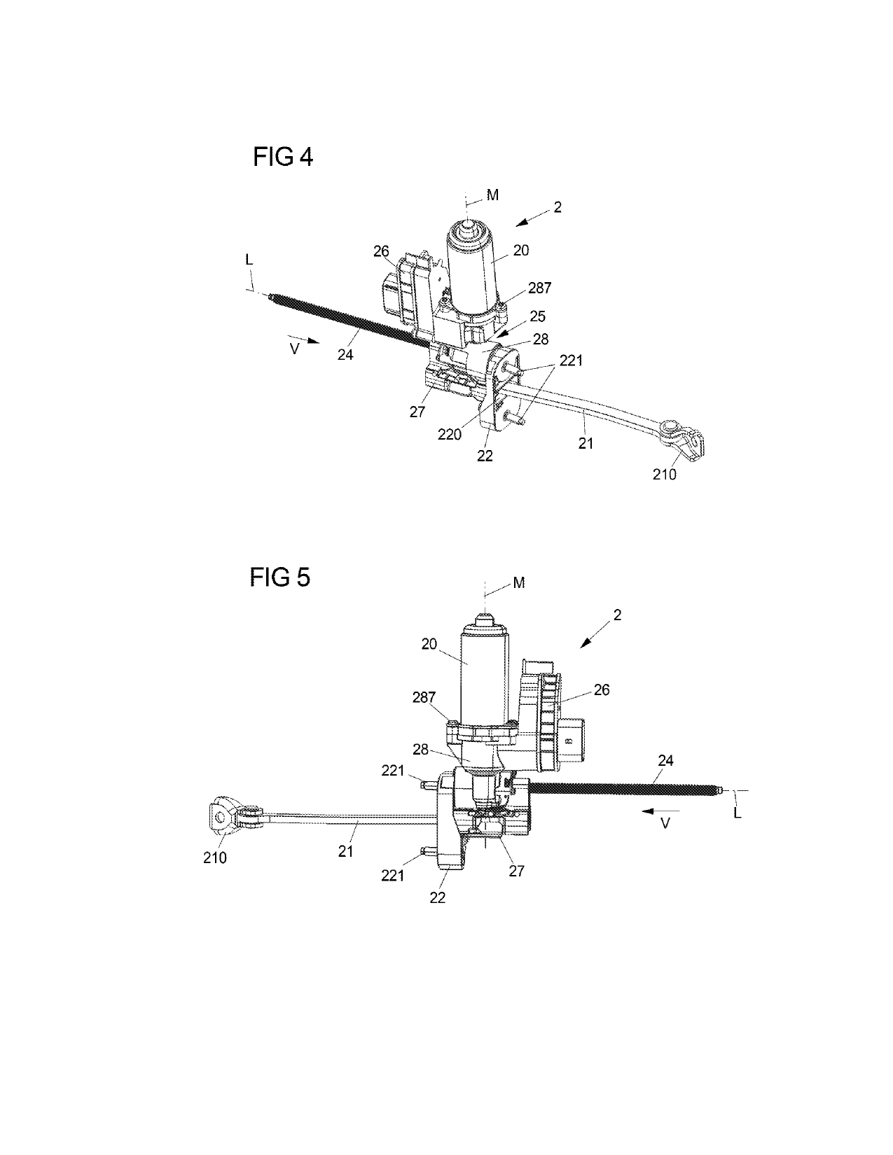

FIGS. 2-15 show views of an exemplary embodiment of a door drive device 2, which is designed to adjust a vehicle door 11 relative to a vehicle body 10. The door drive device 2 has a motor 20, a push rod 21, an adapter element 22, a guide rail 23, a spindle 24, a transmission 25, a control unit 26, and a housing assembly 28 realizing a transmission housing.

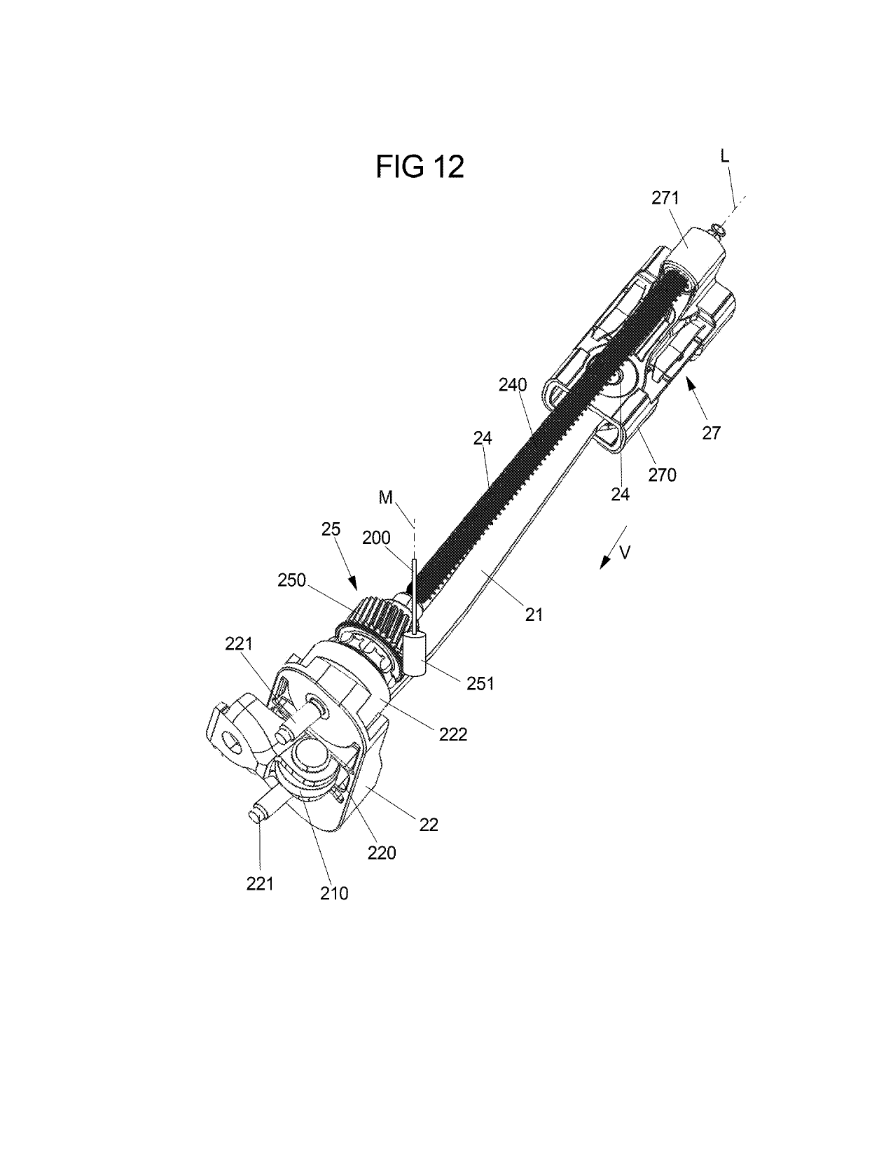

The spindle 24 extends longitudinally along a longitudinal axis L and is rotatable about the longitudinal axis L relative to the housing assembly 28. As can be seen, for example, in FIG. 12, a gear wheel 250 in the form of a spur gear of the transmission 25 is connected to the spindle 24 for conjoint rotation. The gear wheel 250 engages with a drive worm 251, schematically shown in FIG. 12 and arranged on a motor shaft 200 of the motor 20, in such a way that, by rotating the motor shaft 200 with the drive worm 251 arranged on it, the gear wheel 250 can be rotated about the longitudinal axis L, and thus the spindle 24 can be set into a rotary motion about the longitudinal axis L.

A spindle nut element 27 is arranged on the spindle 24 and has a spindle nut portion 271 and a sliding portion 270. The spindle nut element 27 is guided in the guide rail 23 via the sliding portion 270. The spindle nut portion 271 forms a threaded opening through which the spindle 24 engages and which engages with an external thread 240 of the spindle 24. The thread engagement is such that, when the spindle 24 is rotated about the longitudinal axis L, the spindle nut element 27 is adjusted longitudinally along the longitudinal axis L on the spindle 24.

The push rod 21 is articulatedly connected to the spindle nut element 27 at one end 211. By contrast, at one end located away from the end 211, the push rod 21 is articulatedly connected to a connection element 210, via which the push rod 21 (when the door drive device 2 is arranged on the vehicle door 11) can be connected to the vehicle body 10, so that, in an operational state, the push rod 21 is supported in a vehicle 1 between the vehicle door 11 on the one hand and the vehicle body 10 on the other, and the vehicle door 11 can be moved relative to the vehicle body 10 by moving the spindle nut element 27 and by moving the push rod 21 accordingly.

FIGS. 2-5 show the door drive device 2 with the push rod 21 in an extended position, in which the spindle nut element 27 is approached by the housing assembly 28, and the push rod 21 is extended accordingly in an adjustment direction V.

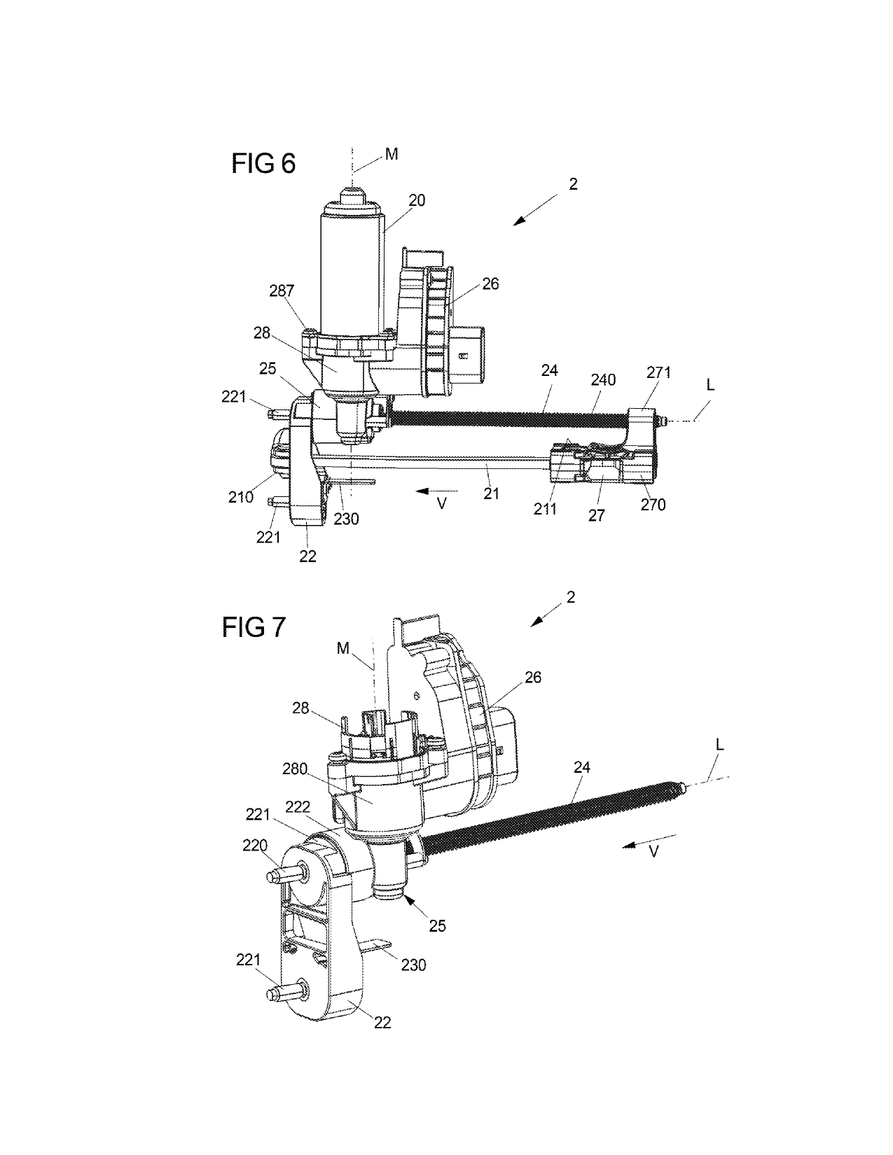

By contrast, FIG. 6 shows the push rod 21 in a retracted position, in which the spindle nut element 27 is removed from the housing assembly 28 in the opposite direction of adjustment V, and the push rod 21 is accordingly retracted into the guide rail 23.

The push rod 21 extends through an opening 220 in the adapter element 22 and can be moved relative to the adapter element 22 by moving the spindle nut element 27.

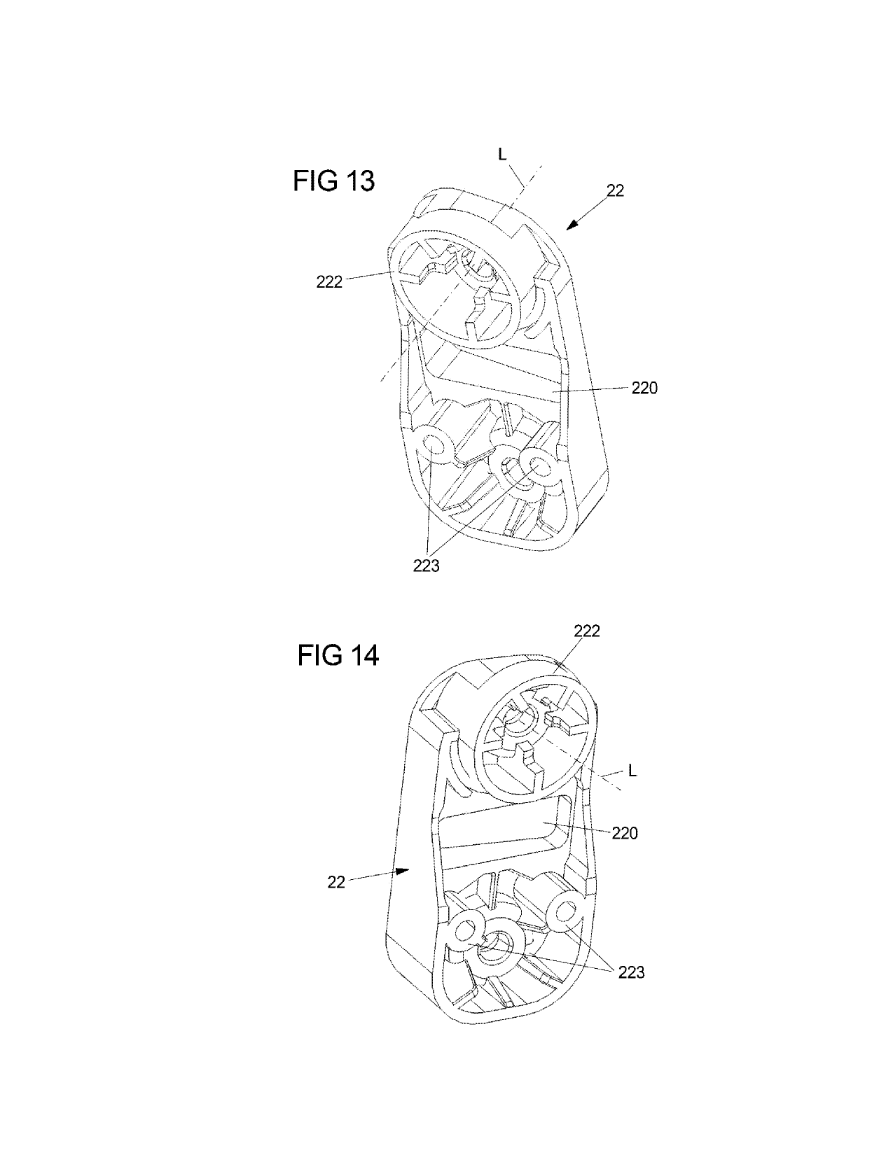

The guide rail 23 is connected to the adapter element 22 at a fastening interface 223, as can be seen from FIGS. 2 and 3 in conjunction with FIGS. 13 and 14. The guide rail 23 can be attached to the adapter element 22 via a mounting bracket 230 (compare FIGS. 6 and 7), in particular screwed in place, so that the guide rail 23 is fixed relative to the adapter element 22.

In a mounted position, the housing assembly 28 is also attached to the adapter element 22. The housing assembly 28 forms a motor interface 287 to which the motor 20 is attached - for example, by screwing the motor 20 to the housing assembly 28.

The housing assembly 28 encloses the transmission 25, in particular the drive worm 251 and the gear wheel 250, and mounts them rotatably. The housing assembly 280 has a drive worm housing 282, within which the drive worm 251 is accommodated. In a housing portion 283, a shaft opening 284 is formed into which the motor shaft 200 of the motor 20 engages. For example, in the housing portion 283, a sensor system for detecting a position and/or movement of the motor shaft 200 can be arranged - for example, an arrangement of Hall sensors.

The adapter element 22 serves to connect the door drive device 2, in the illustrated exemplary embodiment, to the vehicle door 11. For this purpose, fastening elements 221 in the form of screws are arranged on the adapter element 22, via which the adapter element 22 can be screwed to the door inner panel 113 on the inside of the door box enclosed by the vehicle door 11.

While the door drive device 2 can use identical parts with respect to the housing assembly 28 and the guide rail 23 and other functional components (apart from the adapter element 22) for use in different vehicle models, the adapter element 22 represents a vehicle model-specific component that is adapted for use in a particular vehicle model and thus forms a model-specific interface designed according to the wishes of a vehicle manufacturer for attaching the door drive device 2 in the vehicle - for example, on the vehicle door 11 of the specific vehicle model.

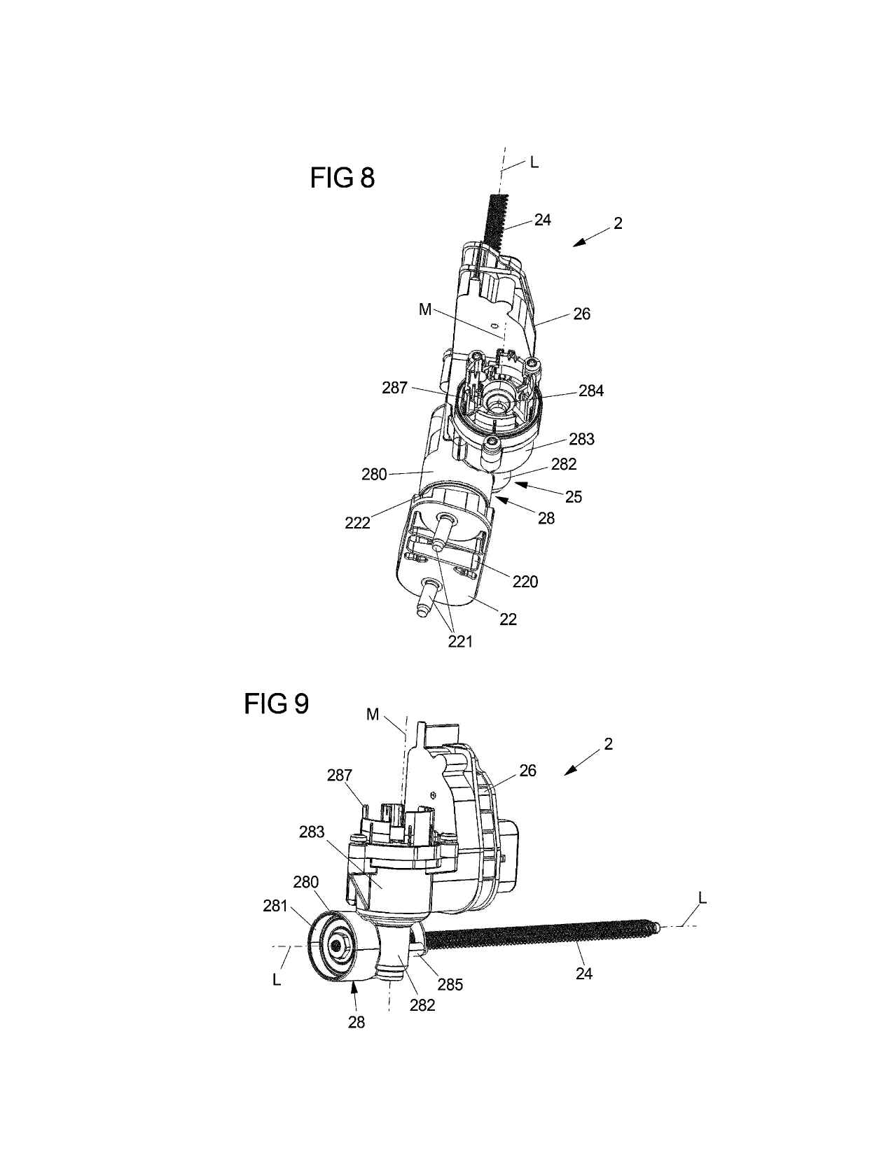

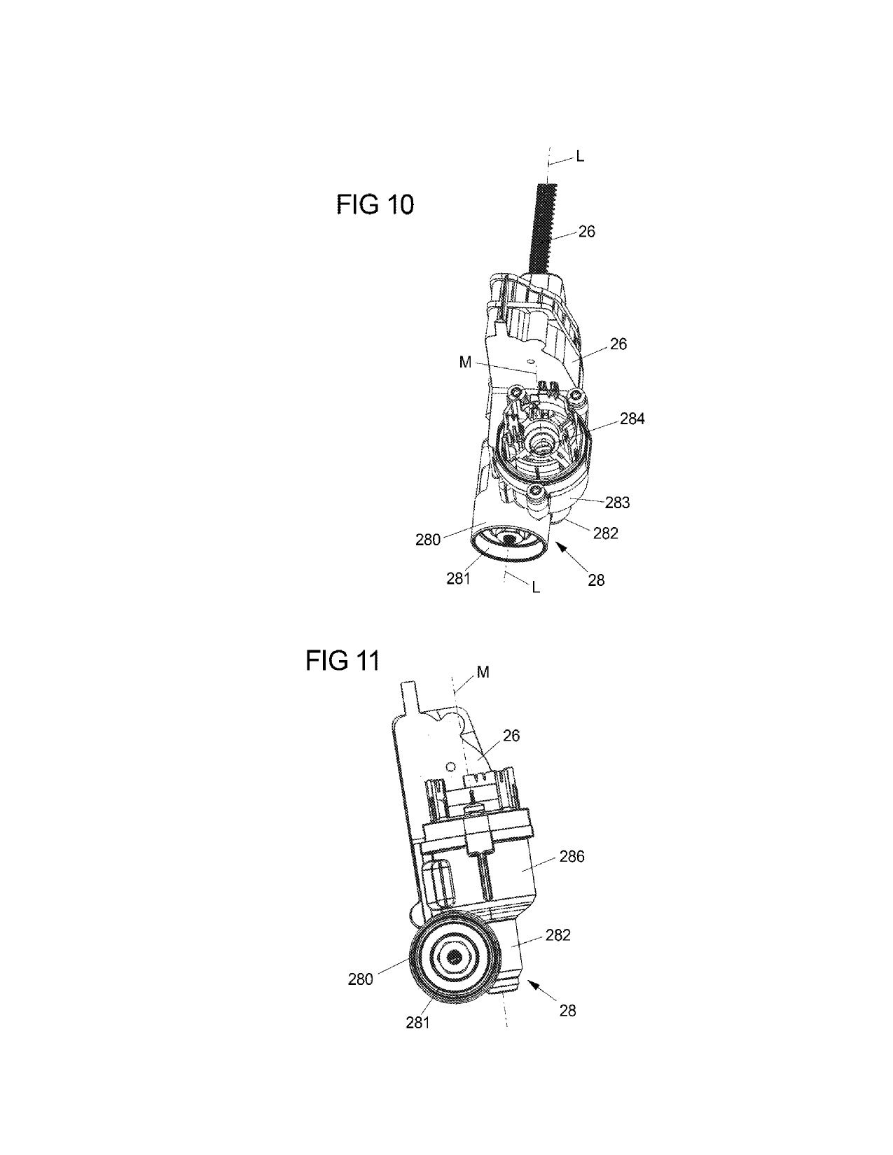

In a pre-assembly state, the housing assembly 28 is separate from the adapter element 22. The housing assembly 28 forms an attachment portion 280 which, as can be seen in particular from FIGS. 8-11, has a hollow-cylindrical shape that is concentric to the longitudinal axis L. Within the attachment portion 280, an opening 281 is formed, as can be seen, for example, in FIGS. 10 and 11.

For assembly, the housing assembly 28 can be attached to an attachment portion 222 of the adapter element 22. As can be seen from FIGS. 12-14, the attachment portion 222 is formed as a cylindrical pin on the adapter element 22 and is designed to be complementary to the attachment portion 280 of the housing assembly 28, such that the attachment portion 280 can be fitted onto the attachment portion 222, and the attachment portion 222 can thus engage in the opening 281 within the attachment portion 280 of the housing assembly 28.

By attachment of the attachment portions 222, 280 of the adapter element 22 and the housing assembly 28, the adapter element 22 and the housing assembly 28 can be positioned against each other for mounting the door drive device 2. Due to the cylindrical shape of the attachment portions 222, 280, the adapter element 22 and the housing assembly 28 can be rotated relative to each other about the longitudinal axis L after the attachment portions 222, 280 have been attached to each other, in order to align the position of the motor axis M of the motor 20, about which the motor shaft 200 is rotatable, relative to the longitudinal axis L.

In this way, the position of the motor 20 on the door drive device 2 can be variably adapted, so that the motor 20, which is connected to the housing assembly 28 via the motor interface 287, can be positioned on the door drive device 2 in different positions rotated relative to each other about the longitudinal axis L.

After the motor axis M is aligned, the attachment portions 222, 280 are firmly connected to each other - for example, by a welded connection or an adhesive connection. A welded connection can be produced, for example, by laser transmission welding, ultrasonic welding, or friction welding. In other configurations, it is also possible, for example, to create a screw connection between the attachment portions 222, 280 and thus to fasten the housing assembly 28 to the adapter element 22.

In the mounted, operational position, the adapter element 22 and the housing assembly 28 are firmly connected to each other, in particular rotationally fixed and positionally fixed, so that the position of the motor 20 in particular is also fixed relative to the adapter element 22.

Because there is a variability in the orientation of the motor axis M relative to the adapter element 22 during assembly, cost savings can be achieved, particularly in the manufacture of the housing assembly 28. Whereas, conventionally, a separate housing design of the housing assembly 28 was required for each different orientation of the motor axis M, the interface provided via the attachment portions 222, 280 allows for variable orientation of the motor 20 relative to the adapter element 22 during assembly, while using a uniform housing design of the housing assembly 28.

The attachment portions 222, 280 are each cylindrical with respect to the longitudinal axis L, along which the spindle 24 extends and to which the gear wheel 250 is also concentric. By rotating the housing assembly 28, the position of the motor axis

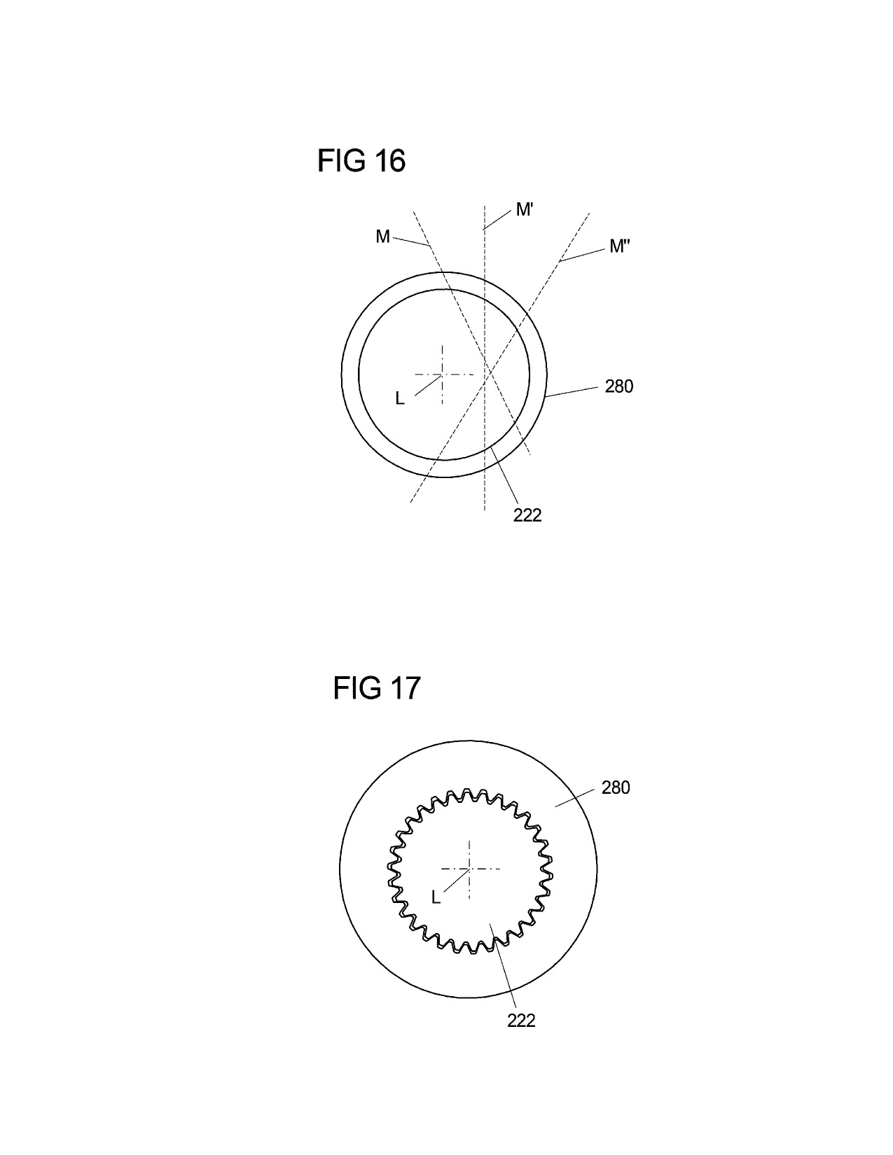

M, M', M'' is adapted, as shown schematically in FIG. 16, wherein the gear engagement between the drive worm 251 and the gear wheel 250 exists equally regardless of the position of the motor axis M, M', M''.

In the exemplary embodiment shown in FIGS. 2-15, the housing assembly 28 and the adapter element 22 can be freely rotated relative to each other during assembly and can be brought into any continuously successive positions relative to each other in order to align the motor axis M relative to the adapter element 22. Alignment is possible over an angle of 360°. In other configurations, alignment over an angular range smaller than 360°, e.g., smaller than 180°, e.g., smaller than 90°, is possible.

In other embodiments, the housing assembly 28 and the adapter element 22 may be connected to each other only in discrete rotational positions. If, for example, the attachment portions 222, 280 each have a toothed portion, as shown schematically in FIG. 17, the attachment portions 222, 280 can be attached to each other in different positions rotated relative to each other about the longitudinal axis L, but only in discrete rotational positions which are angularly spaced relative to each other according to the tooth width of the toothed portions.

With such a design, the attachment of the attachment portions 222, 280 is possible only in discrete positions. Once attached, the attachment portions 222, 280 cannot be freely rotated relative to each other.

Once attached, the adapter element 22 and the housing assembly 28 are firmly connected to each other - for example, by means of a welded connection or an adhesive connection. In other embodiments, a form-fit connection, e.g., a snap-fit connection or a clip connection, can also be used to fix the adapter element 22 and the housing assembly 28 to each other in a rotationally fixed and positionally fixed manner.

As part of the pre-assembly, before connecting the housing assembly 28 to the adapter element 22, when connecting the housing assembly 28 to the adapter element 22, or after connecting the housing assembly 28 to the adapter element 22, the guide rail 23 is connected to the adapter element 22. The guide rail 23 can be connected to the adapter element 22 in exactly one position. Due to the adaptability of the rotational position of the housing assembly 28 relative to the adapter element 22, the rotational position of the housing assembly 28 relative to the guide rail 23 is also variable.

The movement path of the spindle nut element 27 is defined by the guide rail 23. The movement path of the spindle nut element 27 is independent of the rotational position of the housing assembly 28 relative to the adapter element 22.

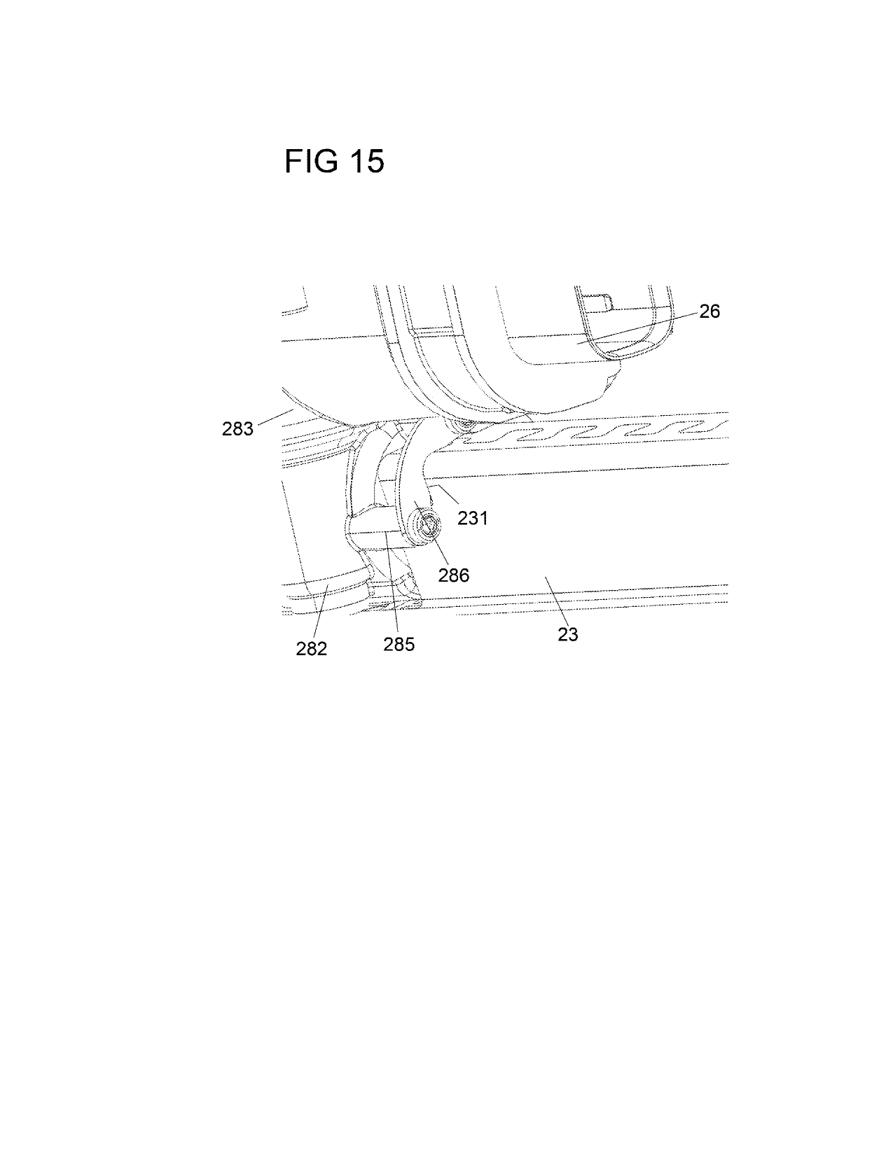

In the illustrated exemplary embodiment, a support element 285 is arranged on the housing assembly 28, by means of which axial support of the guide rail 23 relative to the housing assembly 28 is created. As can be seen from the enlarged view according to FIG. 15, the support element 285 forms a support leg 286 which extends in an arc about the longitudinal axis L and engages in an associated slot opening 231 on the guide rail 23. The support leg 286 is movable about the longitudinal axis L in the slot opening 231 relative to the guide rail 23, so that the housing assembly 28 can assume different rotational positions relative to the guide rail 23. The engagement of the support leg 286 in the slot opening 231 provides, in particular, axial support of the guide rail 23 relative to the housing assembly 28 along the longitudinal axis L under load during operation.

The control unit 26 is used to control the door drive device 2 during operation. For example, in the control unit 26, which may have electronics for this purpose, sensor signals can be processed to detect a motor movement and a motor position and thus to detect a position or movement of the push rod 21.

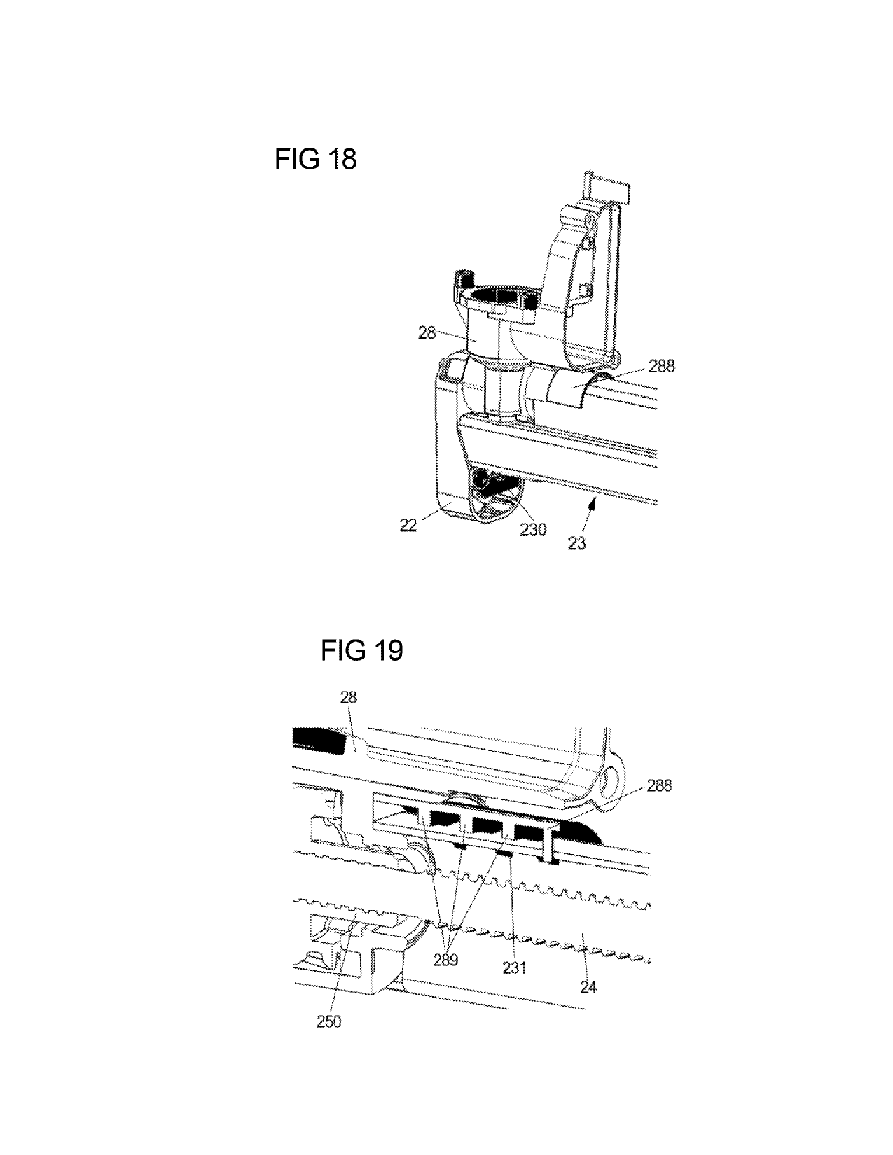

FIGS. 18 and 19 show a further exemplary embodiment in which, in modification of the exemplary embodiment according to FIG. 15, a support element 288 is firmly connected to the housing assembly 28. The support element 288, for example, is designed as a plastic molded part and can therefore be manufactured cost-effectively. The support element 288 is firmly connected to the housing assembly 28, e.g., in that the support element 288 is non-detachably fastened to the transmission housing 28 by means of a welded connection - for example, produced by laser transmission welding and/or ultrasonic welding.

As can be seen from the enlarged partial sectional view according to FIG. 19, the support element 288 extends in an arc shape in the area of the upper wall of the guide rail 23. On one of the inner sides, facing the guide rail 23, of the support element 288, for example, arc-shaped support legs 289 are formed in the form of inwardly projecting ribs, each of which engages in an associated engagement slot 231 on the guide rail 23.

The guide rail 23 is thus supported on the transmission housing 28 via the support element 288, analogously to the exemplary embodiment according to FIG. 15, wherein the housing assembly 28 can assume different rotational positions relative to the guide rail 23, and the housing assembly 28 can thus be adapted in its angular position (about the longitudinal axis L) relative to the adapter element 22 of the guide rail 23 during assembly.

The underlying idea of the proposed solution is not limited to the previously described exemplary embodiments, but can also be realized in other ways.

In principle, a door drive device can be located on the vehicle door or the vehicle body. The push rod is supported on the other assembly in each case, so that moving the push rod can cause a relative movement between the vehicle door and the vehicle body.

The adapter element may have a different shape than shown and is generally designed and built specifically for a particular vehicle model.

### List of reference signs

1 vehicle

10 vehicle body

11 vehicle door

110 door outer panel

111 door module

112 door interior

113 door inner panel

114 hinge axis

2 door drive device

20 motor

200 motor shaft

21 push rod

210 connection element

211 end

22 adapter element

220 opening

221 fastening elements

222 attachment portion

223 mounting interface

23 guide rail

230 mounting bracket

231 slot opening

24 spindle

240 thread

25 transmission

250 gear wheel

251 drive worm

26 control unit

27 spindle nut element

270 sliding portion

271 spindle nut portion

28 housing assembly

280 attachment portion

281 opening

282 drive worm housing

283 housing portion

284 shaft opening

285 support element

286 leg element

287 motor interface

L longitudinal axis

M motor axis

M', M''rotated position of the motor axis

V adjustment direction

1. An assembly for producing a door drive device for adjusting a vehicle door relative to a vehicle body, comprising:
a motor which has a motor shaft that can rotate about a motor axis,
a transmission that has at least one gear wheel,
a housing assembly to which the motor can be connected,
a spindle rotatable about a longitudinal axis,
a push rod, and,
an adapter element for connecting the door drive device to the vehicle door or vehicle body, wherein the housing assembly for mounting the door drive device can be connected to the adapter element, wherein, in a mounted position, the motor is connected to the adapter element via the housing assembly, wherein, in the mounted position, the motor is operatively connected to the spindle via the transmission, and the spindle is driven by the motor and can be rotated about the longitudinal axis in order to move the push rod to adjust the vehicle door, wherein, in a pre-assembly state, the housing assembly can be connected to the adapter element in different positions rotated relative to each other about the longitudinal axis.

2. The assembly according to claim 1, wherein the motor axis is not parallel to the longitudinal axis.

3. The assembly according to claim 1, wherein the motor axis is skewed with respect to the longitudinal axis.

4. The assembly according to claim 1, wherein the motor axis extends along a plane perpendicular to the longitudinal axis.

5. The assembly according to claim 1, wherein the transmission housing has a first attachment portion and the adapter element has a second attachment portion, wherein the first attachment portion and the second attachment portion can be attached to each other in different positions rotated about the longitudinal axis in order to connect the housing assembly to the adapter element.

6. The assembly according to claim 5, wherein the first attachment portion and/or second attachment portion are cylindrically shaped about the longitudinal axis.

7. The assembly according to claim 5, wherein one of the first attachment portion and the second attachment portion has an opening into which the other of the first attachment portion and the second attachment portion can be inserted to connect the housing assembly to the adapter element.

8. The assembly according to claim 5, wherein, in the mounted position, the first attachment portion and the second attachment portion are firmly connected to each other.

9. The assembly according to claim 8, wherein, in the mounted position, the first attachment portion and the second attachment portion are connected to each other in an integrally bonded or form-fitting manner, and/or, in the mounted position, the first attachment portion and the second attachment portion are connected together by means of a welded connection or an adhesive connection.

10. The assembly according to claim 5, wherein the first attachment portion and the second attachment portion can be connected to each other in positions continuously adjacent to each other about the longitudinal axis or in discrete positions spaced at an angle to each other about the longitudinal axis.

11. The assembly according to claim 1, having a spindle nut element for moving the push rod, wherein the spindle nut element in the mounted position is in threaded connection with the spindle such that, by rotating the spindle, the spindle nut element can be moved along the longitudinal axis relative to the spindle.

12. The assembly according to claim 11, wherein the push rod in the mounted position is articulatedly connected to the spindle nut element.

13. The assembly according to claim 12, having a guide rail for guiding the spindle nut element, wherein the guide rail is formed on the adapter element or at least is attached in the mounted position to a mounting interface of the adapter element.

14. The assembly according to claim 13, wherein the housing assembly is movable about the longitudinal axis relative to the guide rail in the pre-assembly state.

15. The assembly according to claim 14, wherein a component unit from the group consisting of the housing assembly and the guide rail has a support element which, in the pre-assembly state, is supported on the other component unit from the group consisting of the housing assembly and the guide rail in a manner movable about the longitudinal axis.

16. The assembly according to claim 15, wherein the support element has a support leg which engages in a slot opening of the other component unit from the group of housing assembly and guide rail and is movable in the slot opening about the longitudinal axis.

17. The assembly according to claim 1, wherein the housing assembly in the mounted position accommodates the at least one gear wheel of the transmission, and/or
the housing assembly has a motor interface for connecting the motor to the housing assembly.

18. The assembly according to claim 1, wherein the adapter element has an opening through which the push rod extends in the mounted position, and/or the adapter element has at least one fastening element for firmly connecting the adapter element to the vehicle door or the vehicle body.

19. A door drive device produced using an assembly according to claim 1, wherein the door drive device comprises:
a motor which has a motor shaft that can rotate about a motor axis,
a transmission that has at least one gear wheel,
a housing assembly to which the motor is connected,
a spindle rotatable about a longitudinal axis,
a push rod, and,
an adapter element for connecting the door drive device to the vehicle door or vehicle body, wherein the housing assembly is connected to the adapter element, wherein the motor is connected to the adapter element via the housing assembly, wherein the motor is operatively connected to the spindle via the transmission, and the spindle is driven by the motor and can be rotated about the longitudinal axis in order to move the push rod to adjust the vehicle door, wherein the housing assembly is connected to the adapter element from one of several different positions rotated relative to each other about the longitudinal axis.

20. A method for producing a door drive device using an assembly according to claim 1, wherein the method comprises:
providing a motor which has a motor shaft that can rotate about a motor axis,
providing a transmission that has at least one gear wheel,
providing a housing assembly to which the motor can be connected,
providing a spindle rotatable about a longitudinal axis,
providing a push rod, and,
providing an adapter element for connecting the door drive device to the vehicle door or vehicle body, wherein the housing assembly for mounting the door drive device is connected to the adapter element, such that, in a mounted position, the motor is connected to the adapter element via the housing assembly, wherein, in the mounted position, the motor is operatively connected to the spindle via the transmission, and the spindle is rotatable about the longitudinal axis driven by the motor in order to move the push rod for adjusting the vehicle door, wherein connecting the housing assembly to the adapter element comprises: aligning the motor axis relative to the longitudinal axis by connecting the housing assembly to the adapter element in a plurality of different positions rotated relative to each other about the longitudinal axis.
